(19) United States
(12) Patent Application Publication
(10) Pub. No.: US 2026/0281636 A1
(43) Pub. Date: Sep. 17, 2026

(54) EAR TIP FOR A HEARING DEVICE AND HEARING DEVICE

(71) Applicants: Widex A/S, Lynge (DK); SIVANTOS PTE. LTD., Singapore (SG)

(72) Inventors: Ib MARCHER, Helsinge (DK); Franz CLASSNITZ, Singapore (SG)

(73) Assignees: Widex A/S, Lynge (DK); SIVANTOS PTE. LTD., Singapore (SG)

(21) Appl. No.: 19/479,758

(22) PCT Filed: Apr. 2, 2024
(86) PCT No.: PCT/EP2024/058911

§ 371 Date: Oct. 29, 2025

(30) Foreign Application Priority Data
May 3, 2023 (DK) PA202330010

(51) Int. Cl. H04R 25/00

(52) U.S. Cl. CPC H04R 25/656; H04R 2225/0216

(57) ABSTRACT

The invention refers to an ear tip (1) for a hearing device (2), comprising a main body (4). The main body (4) comprises an outer wall (6) forming a hollow thimble-like structure closed except for a sound transmission opening (12) at a first end (8) and open like a cup at a second end (10), the first end (8) and the second end (10) being opposed to each other along an insertion axis (14), and at least a pair of ribs (16) separated from each other in circumferential direction (18) and protruding from the outer wall (6) radially inside leaving open a radially inside core region (22). The outer wall (6) and the ribs (16) are made of a flexible material.

The invention relates to an ear tip for a hearing device as well as to a hearing device comprising such ear tip.

Hearing devices are usually used to output a sound signal to the hearing of the wearer of this hearing device. The output takes place by means of an output transducer, usually acoustically via airborne sound by means of a loudspeaker (also referred to as a “receiver”). Such hearing devices are often used as so-called hearing aids. For this purpose, the hearing devices normally comprise an acoustic input transducer (in particular a microphone) and a signal processor which is set up to process the input signal (also: microphone signal) generated by the input transducer from the ambient sound using at least one signal processing algorithm, usually stored in a user-specific manner, in such a way that a hearing loss of the wearer of the hearing device is at least partially compensated. In particular in the case of a hearing aid, the output transducer can be, besides a loudspeaker, alternatively a so-called bone conduction receiver or a cochlear implant, which are set up for the mechanical or electrical coupling of the sound signal into the hearing of the wearer. The term hearing devices additionally includes, in particular, devices such as so-called tinnitus maskers, headsets, headphones and the like.

Typical designs of hearing devices, in particular hearing aids, are behind-the-ear (“BTE”) and in-the-ear (“ITE”) hearing devices. These designations refer to the intended wearing position. In-the-ear hearing aids have a (main) housing that is worn behind the auricle. A distinction can be made between models whose loudspeaker is located in this housing—the sound is usually emitted to the ear by means of a sound tube that is worn in the ear canal—and models that have an external loudspeaker that is placed in the ear canal. In-the-ear hearing aids, on the other hand, have a housing that is worn in the pinna or even completely in the ear canal.

For effective sound transmission to the eardrum, a sealed seat of the sound output part of the respective hearing device within the ear canal is usually crucial. Best results may be reached most of times with custom fit earmolds. For that, a hearing care professional usually has to take an ear impression or a 3D scan of the ear canal. That manufacture method of the earmold is cost and time consuming and needs a respective infrastructure which is not always at hand.

The invention is based on the need for an affordable and yet comfortable and functional ear tip.

That problem is solved according to the invention by the features of claim 1. Also, that problem is solved according to the invention by the features of claim 11. Advantageous embodiments and further developments of the invention, some of which are inventive in themselves, are set forth in the dependent claims and the following description.

The ear tip according to the invention is designed and provided for the use with a hearing device, especially a hearing aid. The ear tip comprises a main body. The main body comprises an outer wall forming a hollow thimble-like (or: cap-like) structure that is closed at a first (“distal”) end except for a sound transmission opening (also: “port”). The thimble-like structure is open at a second end similar to a cup. The first end and the second end are opposed to each other along an insertion axis (along which the ear tip is to be inserted into the ear canal for intended usage). The main body further comprises at least a pair of ribs that are separated from each other in a circumferential direction and protrude from the outer wall radially to the inside of the main body (especially into the thimble-like structure) leaving open a core region located radially inside of the thimble-like structure. The outer wall and the ribs are made of a flexible material. “Flexible” is used in the context of this application in the sense of having lower deformation resistance as compared to materials that may not easily be bent or deformed otherwise, however, having high resilience capabilities. Preferably such characteristics may be compared with such of elastomeric material such as rubber and the like.

Preferably, the main body comprises at least four of said ribs protruding from the outer wall. Expediently, the number of such ribs is even.

The design of the main body as described above may be compared to an umbrella, i.e. the outer wall would correspond to the membrane that shows low deformation resistance and the ribs would correspond to the tension rods (also referred to as “spokes” or “quills”) that spread out the membrane into its typical dome-like shape. Accordingly, the ribs give the thimble-like structure some amount of structural stability against deformation, on the one hand, and, on the other hand, the ribs enable the outer wall to be deformed easily between the ribs, especially in radial and/or circumferential direction. Thus, the ear tip shows a high amount of flexibility. However, compared to a simple structure having only a flexible dome-like wall, the ear tip also shows a quite high amount of resilience such that the ear tip according to the invention is enabled to conform sealingly, especially air-tight, to a high count of different ear canal geometries. Therefore, the ear tip is particularly suitable for hearing devices that are not intended to be personally fitted in their geometry to the respective ear of a user.

The insertion axis preferably resembles a longitudinal axis of the ear tip.

In a preferred embodiment the ribs are pairwise opposed to each other with respect to the insertion axis. More preferred, the ribs are aligned with equal gaps in circumferential direction. That makes up for an at least approximately (i.e. exact or within usual tolerances) stepwise rotationally symmetric deformation behavior.

According to an expedient embodiment, the ribs extend from the first (distal) end over only a part of the length of the outer wall along the insertion axis. Therefore, the outer wall will show less deformation resistance in the region of the second end than at the distal end. That enables for a comfortable seating of the ear tip within the ear canal as well as for a gentle contact to the ear canal.

In particular, the cross section of the main body is smaller at the first end than at the second end.

In order to reduce the deformation resistance of the outer wall counter to the insertion direction, according to a further expedient embodiment the ribs reduce in height in direction to the second end. That means that their radial protrusion is reduced towards the second end. That reduction of the ribs' height may be realized by at least one step and/or continuously.

Alternatively or additionally, that height reduction of the ribs serves to clear installation (or insertion) space for the insertion of a hearing device component (e.g. an external receiver unit or even a distal end of an in the ear hearing device) into the main body.

According to a preferred embodiment the main body of the ear tip is made as a one-part element. Particularly, the ribs and the outer wall are formed monolithically (i.e. in one production step from the same material).

According to an expedient embodiment the main body comprises a center projection that protrudes from the first end in direction to the second end, preferably within the above mentioned core region. That center projection is preferably formed with a form locking structure for reception of a hearing device component. Most preferred, that form locking structure is a center bore with at least one undercut or recess wherein the hearing device component may lock into.

That center projection and its form locking structure are preferably designed rotationally symmetric such that the hearing device may be mounted in any rotational position relative to the ear tip.

According to a further expedient embodiment the form locking structure in its design as center bore opens through the outer wall to the outside front of the distal end of the main body. Preferably, such opening is resembled by the aforementioned sound transmission port.

According to another expedient embodiment there is provided a circumferential (preferably rotational symmetrical) clearance between the center projection and the outer wall as well as the ribs. In other words, the center projection is not attached on its outside to the ribs or the outer wall. That enables a defined pull or holding force at each circumferential point for the hearing device component attached to the ear tip.

Preferably, the center projection is also formed as one-part (preferably monolithically) with the ribs and the outer wall.

According to a preferred embodiment the main body is made of a silicone rubber material. Silicone rubbers are biologically inert and can be cleaned and disinfected quite easily for many times without or at least with very little negative impact.

According to an optional embodiment the main body has an elliptical cross section. That may be advantageous since the ear canal is often also elliptical.

According to a further optional embodiment at least some of the ribs may to some extent be cut out or reduced further in height compared to other ribs in order to generate more reception space for the hearing device to be mounted.

The hearing device according to the invention comprises the ear tip as described above, preferably as a repeatably connectable element.

Preferably, the hearing device is a hearing aid.

The conjunction “and/or” is to be understood here and in the following in particular in such a way that the features linked by means of this conjunction can be formed both together or as alternatives to each other.

The term “form locking” (also: “positive locking”) between at least two interconnected parts is understood, here and in the following, to mean in particular that the interconnection of the interconnected parts takes place at least in one direction by direct interlocking of contours of the parts themselves or by indirect interlocking via an additional connecting part. The “locking” of a reciprocal movement in this direction thus takes place due to the form of the respective parts.

In the following, examples of the invention are explained in more detail with reference to a drawing. Therein show:

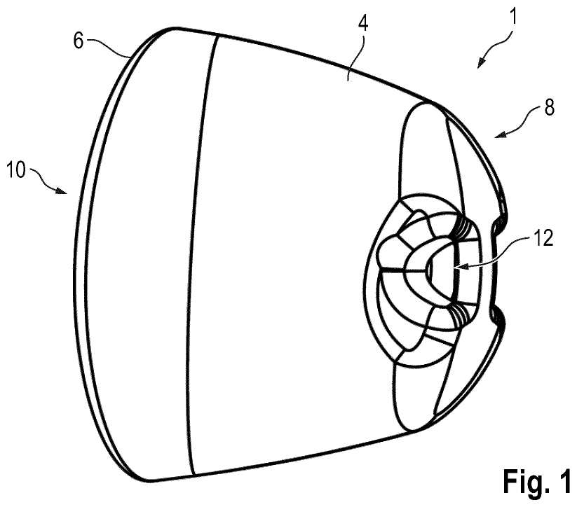

FIG. 1 in a perspective view onto a first end schematically an ear tip for a hearing device,

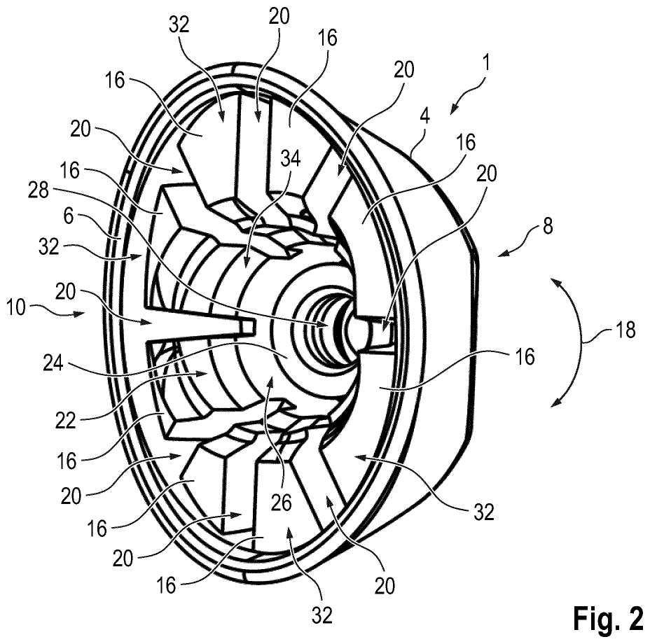

FIG. 2 in a perspective view onto a second end the ear tip,

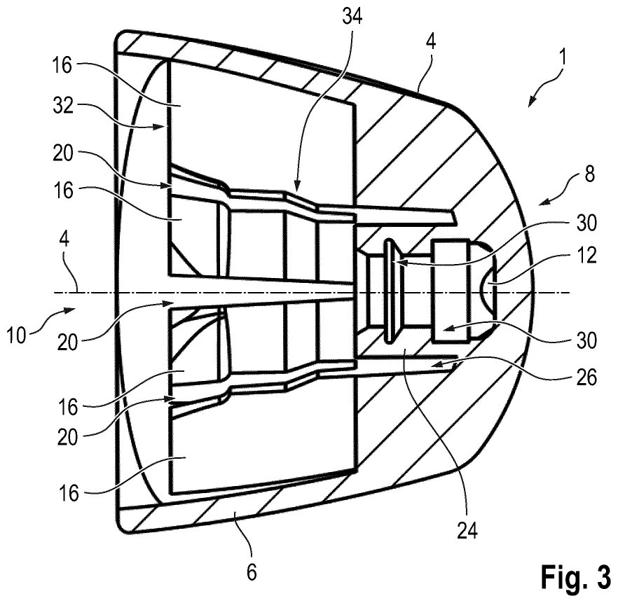

FIG. 3 a longitudinal cut view of the ear tip, and

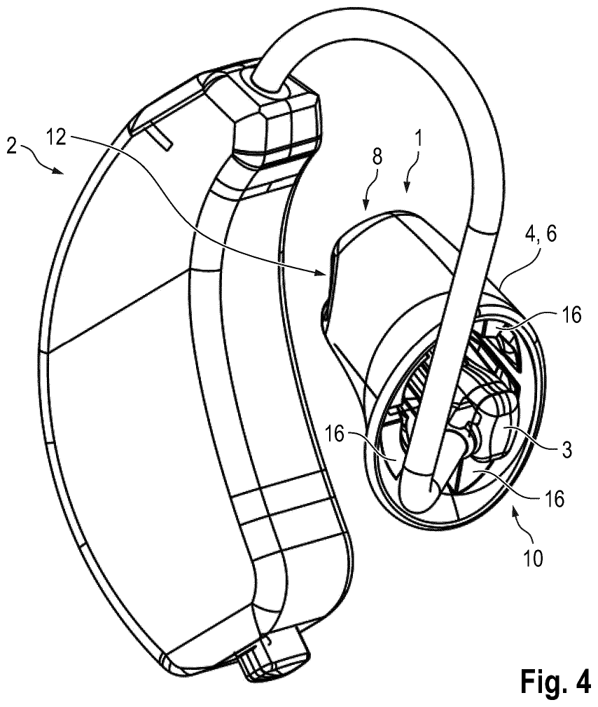

FIG. 4 in a perspective side view schematically the hearing device with an alternative embodiment of the ear tip.

Parts Corresponding to One Another in All Figures Are Always Provided With the same reference signs.

FIG. 1 to 3 show an ear tip 1 that is designed for being connected to a hearing device, especially a hearing aid 2 (s. FIG. 4). The hearing aid 2 is designed as a behind the ear device with an external receiver unit 3. The ear tip 1 is provided to hold the external receiver unit 3 within the ear canal (not shown) and also to realize a tight (and sealing) seat of the ear tip 1 and the external receiver unit 3 within the ear canal. The latter especially without the need of individual fitting and manufacturing.

For these purposes the ear tip 1 comprises a main body 4. The main body 4 is formed by an outer wall 6 that has a thimble-or cup-like structure. That means that the outer wall 6 forms a closed distal end 8 and an open end 10. The distal end 8, however, is not completely closed but has a sound transmission port 12 which is parted in two openings in the present embodiment. The distal end 8 and the open end 10 (or rear end) are aligned opposite each other along an insertion axis 14 (s. FIG. 3), along which the ear tip 1 is to be inserted into the ear canal for intended wearing.

Additionally, the main body 4 comprises several pairs of ribs 16, here there are four pairs. These ribs 16 are aligned at least roughly parallel to the insertion axis 14 and protrude from the outer wall 6 radially inwards. Let alone a front region near the distal end 8 the ribs 16 are separated from each other in the circumferential direction 18 by gaps 20 (s. FIG. 2). The ribs 16 leave open a radially inner space 22 (or core region).

Further, the main body 1 comprises a center projection 24. That projection 24 protrudes from the distal end 8 along the insertion axis 14. The projection 24 is formed with a circumferential clearance (or: “gap 26”) towards the ribs 16 and the outer wall 6. Both the center projection 24 and the gap 26 are designed rotationally symmetric.

The center projection 24 has a (central) bore 28 that is designed for a form locking structure for the hearing aid 2 to be held within the ear tip 1. In detail, the bore 28 has two undercuttings 30 wherein a spout of the hearing aid 2 may lock into with respective projections (not shown). Additionally, the bore 28 opens into the sound transmission port 12.

The main body 4 is formed integrally from a silicone rubber.

Further, the main body 4 has an elliptical cross section, as it can be seen form FIGS. 1 and 2.

The ribs 16 together with the outer wall 6 resemble an umbrella-like design. The separated ribs 16 give the outer wall 6 stability and, yet, allow for a high degree of flexibility such that the outer wall 6 may conform to the ear canal and realize a tight and, especially, a sealed fit. Especially, the gaps 20 between the ribs 16 enable the outer wall 6 to build some kind of film hinge.

Further, the ribs 16 are designed to fill the ear tip 1, especially the inner space 22, with as much volume of material as possible in order to provide a high degree of passive attenuation of sound from the environment to the inner ear canal. Therefore, the ribs 16 increase in volume towards the distal end 8. However, the ribs 16 are also reduced in length by a step 30 to adaptively seal a variety of ear shapes by providing further flexibility to the open end 10 of the tip 1. The combination of an as high material volume at the distal end 8 as possible, the ribs 16 with gaps 20 for adaptive flexibility and the step 30 to the outer wall 6 towards the open end 10 enable for a good compromise of high passive sound attenuation and adaptive flexibility for tight sealing of the ear against sound leakage.

To clear space for the hearing aid 2, especially for the external receiver unit 3, when inserted into the ear tip 1, the ribs 16 are reduced in height (i.e. in their radial dimension) by a further step 34. That can be seen in FIGS. 2 and 3.

As can be seen from FIG. 4, the ear tip 1 according to another embodiment may also be designed in an asymmetric shape seen in a longitudinal direction. Such a shape can be a shape adapted to the shape of a representative ear canal such that not all deformation has to be compensated for by the structure of the ear tip 1.

The center projection 24 preferably has a rotationally symmetric (and especially cylindrical) outer shape which in connection with the circumferential gap 26 allows for a defined, especially a homogenous, pull out force around the whole center projection 24 for demounting the hearing aid 2.

The object of the invention is not limited to the embodiment example described above. Rather, further embodiments of the invention can be derived by the skilled person from the above description.

### LIST OF REFERENCE SIGNS

1 ear tip
2 hearing aid
3 external receiver unit
4 main body
6 outer wall
8 end
10 end
12 sound transmission port
14 insertion axis
16 rib
18 circumferential direction
20 gap
22 inner space
24 projection
26 gap
28 bore
30 undercutting
32 step
34 step

1. An ear tip for a hearing device, comprising a main body having
an outer wall forming a hollow thimble-like structure closed except for a sound transmission opening at a first end and open like a cup at a second end, the first end and the second end being opposed to each other along an insertion axis
at least a pair of ribs separated from each other in circumferential direction and protruding from the outer wall radially inside leaving open a radially inside core region the outer wall and the ribs being made of a flexible material.

2. The ear according to claim 1, wherein at least four ribs protrude from the outer wall.

3. The ear according to claim 2, wherein the ribs are pairwise opposed to each other.

4. The ear tip according to claim 1, wherein the ribs extend from the first end over only a part of the length of the outer wall along the insertion axis

5. The ear tip according to claim 1, wherein the ribs reduce in height in direction to the second end.

6. The ear according to claim 1, wherein the ribs are made monolithically with the outer wall.

7. The ear according to claim 1, wherein a center projection protrudes from the first end in direction to the second end preferably within the core region the center projection being formed with a form locking structure for reception of a hearing device component.

8. The ear tip according to claim 7, wherein there is a circumferential clearance between the center projection and the outer wall as well as the ribs

9. The ear according to claim 1, wherein the main body is made of silicone rubber.

10. The ear tip according to claim 1, wherein the main body has an elliptical cross section.

11. A hearing device especially hearing aid, having an ear tip according to claim 1.
